(19) United States
(12) Patent Application Publication
(10) Pub. No.: US 2010/0228510 A1
(43) Pub. Date: Sep. 9, 2010

(54) Quality Information Control Analysis System

(75) Inventor: Hidetoshi Okubo, Hadano-shi (JP)

Correspondence Address: COOPER & DUNHAM, LLP, 30 Rockefeller Plaza, 20th Floor, NEW YORK, NY, 10112, US

(73) Assignee: RICOH COMPANY, LTD., TOKYO (JP)

(21) Appl. No.: 12/718,702

(22) Filed: Mar. 5, 2010

(30) Foreign Application Priority Data
Mar. 6, 2009 (JP) 2009-053961

(51) Int. Cl. G06F 19/00

(52) U.S. Cl. 702/81

(57) ABSTRACT

A quality information collection analysis system includes at least one assembly installation having at least one assembly machine which assembles a component, and outputs an assembly time of an assembly as a production time, at least one inspection machine which inspects the assembly to which the component is assembled by the assembly machine, and outputs an inspection result of the assembly as inspection information, and a quality collection analysis device which manages quality information of the assembly, having a storing section which stores information of the component, the production time and the inspection information and a quality information collection analysis section which analyzes a defect factor of the assembly by using the information of the component, the production time and the inspection result.

### PRIORITY CLAIM

The present application is based on and claims priority from Japanese Patent Application No. 2009-053961, filed on Mar. 6, 2009, the disclosure of which is hereby incorporated by reference in its entirety.

### BACKGROUND OF THE INVENTION

1. Field of the Invention

The present invention relates to a quality information collection analysis system which collects quality information in a production installation and searches the contents.

2. Description of the Related Art

As for a system or a method which collects quality information in a production installation and displays the information, a method which automatically retrieves identification information and quality information of an assembly, and displays the results, is known.

JP 2002-163011A discloses, for example, an invention which sends identification information, quality information and production-related information of an assembly as quality data, gathers the quality data, and displays the gathered data by means of a table or a graph, for the purpose of providing a production management system, a production management method and the like capable of effectively and promptly managing a product manufactured in an assembly and production line.

In the above-described invention, inspection is performed with respect to each installation, so that information such as many defects can be estimated when the inspection time for one installation is different from a normal time. However, when several machines such as a machine A, a machine B and a machine C are provided in one installation, for example, it is difficult to figure out whether or not the machine A spends an excessive assembling and inspection time, or whether or not the machine B spends an excessive assembling and inspection time. For this reason, it is difficult to specify defects arising from each machine. Here, the installation includes a line having a plurality of independent machines.

### SUMMARY OF THE INVENTION

It is, therefore, an object of the present invention to provide a quality information collection analysis system which can promptly determine a cause of a defect in a production installation.

In order to achieve the above object, the present invention provides a quality information collection analysis system including at least one assembly installation having at least one assembly machine which assembles a component, and outputs an assembly time of an assembly as a production time, at least one inspection machine which inspects the assembly to which the component is assembled by the assembly machine, and outputs an inspection result of the assembly as inspection information, and a quality collection analysis device which manages quality information of the assembly, having a storing section which stores information of the component, the production time and the inspection information and a quality information collection analysis section which analyzes a defect factor of the assembly by using the information of the component, the production time and the inspection result.

### BRIEF DESCRIPTION OF THE DRAWINGS

The accompanying drawings are included to provide further understanding of the invention, and are incorporated in and constitute a part of this specification. The drawings illustrate an embodiment of the invention and, together with the specification, serve to explain the principle of the invention.

FIG. 1 is a block diagram illustrating a flow of information in a quality information collection analysis system according to an embodiment of the present invention.

FIG. 2 is a view illustrating an example of a production time storing table in the quality information collection analysis system according to the embodiment of the present invention.

FIG. 3 is a view illustrating an example of an inspection information storing table in the quality information collection analysis system according to the embodiment of the present invention.

FIG. 4 is a view illustrating an example of a defector factor table in the quality information collection analysis system according to the embodiment of the present invention.

FIG. 5 is a view illustrating an example of a component composition table in the quality information collection analysis system according to the embodiment of the present invention.

FIG. 6 is a view illustrating an example of a component shape table in the quality information collection analysis system according to the embodiment of the present invention.

FIG. 7 is a view illustrating an example of a used machine table in the quality information collection analysis system according to the embodiment of the present invention.

FIG. 8 is a view illustrating relationships among tables in the quality information collection analysis system according to the embodiment of the present invention.

FIG. 9 is a block diagram illustrating an information flow in a quality information collection analysis system according to the embodiment of the present invention.

FIG. 10 is a view illustrating an example of a machine information storing table in a quality information collection analysis system according to the embodiment of the present invention.

FIG. 11 is a view illustrating relationships among tables in the quality information collection analysis system according to the embodiment of the present invention.

FIG. 12 is a stacked bar graph illustrating the number of defects according to defective item in an inspection 1 of a machine type 13.

FIG. 13 is a stacked bar graph illustrating the number of defects according to lot in the inspection 1 of the machine type β.

FIG. 14 is a view illustrating an example of a table according to the embodiment of the present invention.

FIG. 15 is a block diagram illustrating each assembly installation of the quality information collection analysis system according to the embodiment of the present invention.

### DETAILED DESCRIPTION OF THE PREFERRED EMBODIMENT

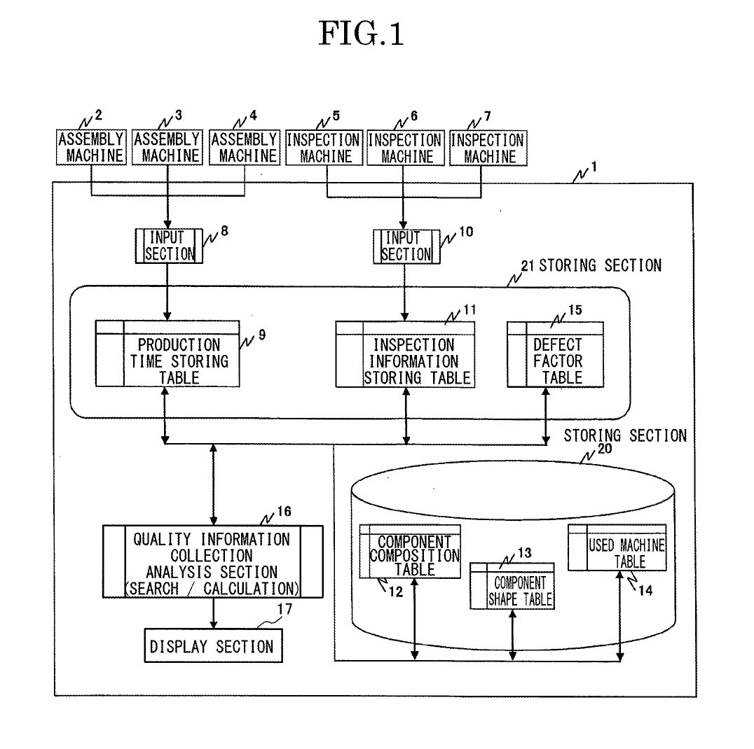

FIG. 1 is a view illustrating a flow of data necessary for a quality information collection analysis system according to the embodiment of the present invention. The quality information collection analysis system according to the embodiment of the present invention will be described with reference to FIG. 1.

The quality information collection analysis system includes an assembly machine 2, an assembly machine 3, an assembly machine 4, an inspection machine 5, an inspection machine 6, an inspection machine 7 and a quality collection analysis device 1.

The quality collection analysis device 1 includes an input section 8, an input section 10, a quality information collection analysis section 16, a storing section 20 and a storing section 21.

The storing section 21 includes a table 9 for storing a production time according to the machine (production time storing table 9), a table 11 for storing inspection information (inspection information storing table 11) and a table 15 for storing defect factors (defect factor table 15). The storing section 20 includes a table 12 for storing component constitutions (component constitution table 12), a table 13 for storing component shapes (component shape table 13), and a table 14 for storing used machines (used machine table 14).

The quality information collection analysis section 16 refers to the production time storing table 9, the inspection information storing table 11, the defect factor table 15, the component composition table 12, the component shape table 13 and the used machine table 14, and analyzes the information stored in each table.

The assembly installation 2 includes a plurality of assembly machines and produces an assembly by assembling assembly components in a defined order. Each assembly machine includes a unit which sends to the quality collection analysis device 1 a time when an assembly component is assembled.

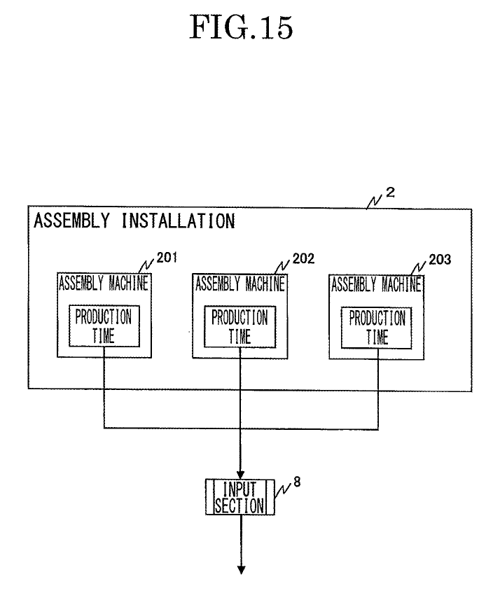

As illustrated in FIG. 15, for example, the assembly installation 2 includes an assembly machine 201, an assembly machine 202 and an assembly machine 203. The assembly machine 201 outputs a production time to the input section 8 when the assembly of an assembly component is completed. Next, the assembly machine 202 outputs a production time to the input section 8 when the assembly of an assembly component is completed. Then, the assembly machine 203 outputs a production time to the input section 8 when the assembly of an assembly component is completed. The structures of the assembly installations 3, 4 are similar to the above-described structure of the assembly installation 2.

The inspection machine 5 includes a unit which inspects an assembly to which assembly components are assembled by each assembly installation, and sends to the quality collection analysis device 1 the results of the inspection such as identification information and existence of a defect of an inspected product, and a defect type and an address of a defective component when the inspected product has a defect. The structures of the inspection machines 6, 7 are similar the structure of the inspection machine 5.

A production time (production start time or production end time) of each assembly machine in each installation is input to the input section 8. For example, a time when an assembly passes through an assembly machine is input as a production time.

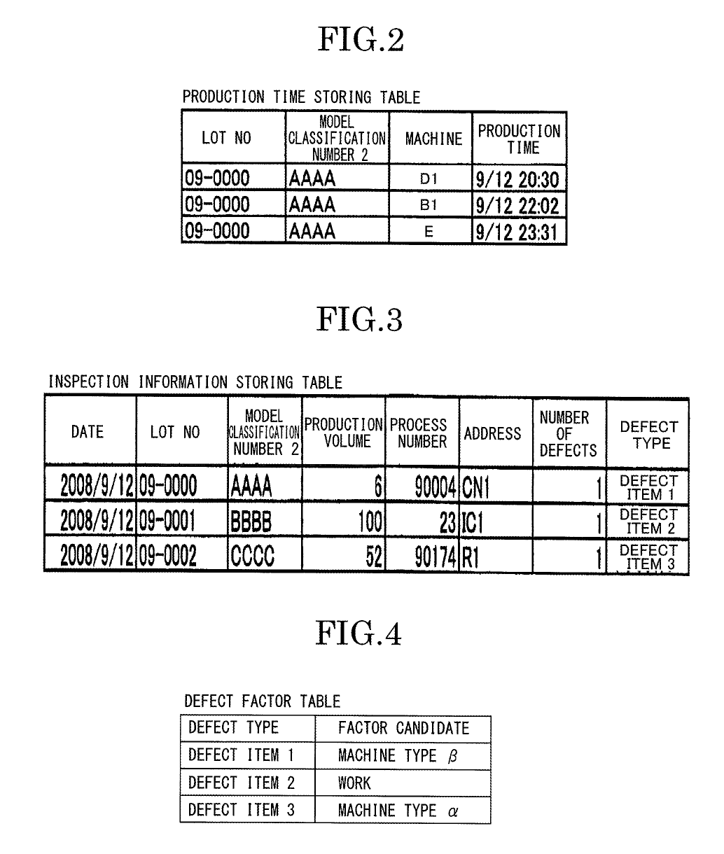

The production time storing table 9 stores, as illustrated in FIG. 2, a production time (production start time or production end time) of each machine in each assembly installation input to the input section 8. This table includes a lot number, a model classification number 2, a machine name, a production time (production start time or production end time) and the like.

The inspection results of the assembly output from the inspection machines are input to the input section 10.

The inspection information storing table 11 stores, as illustrated in FIG. 3, an inspection result of each assembly input to the input section 10. This table includes a lot number, a model classification number 2, a production volume, a process number, an address, the number of defects, an inspection result (defect type) and the like.

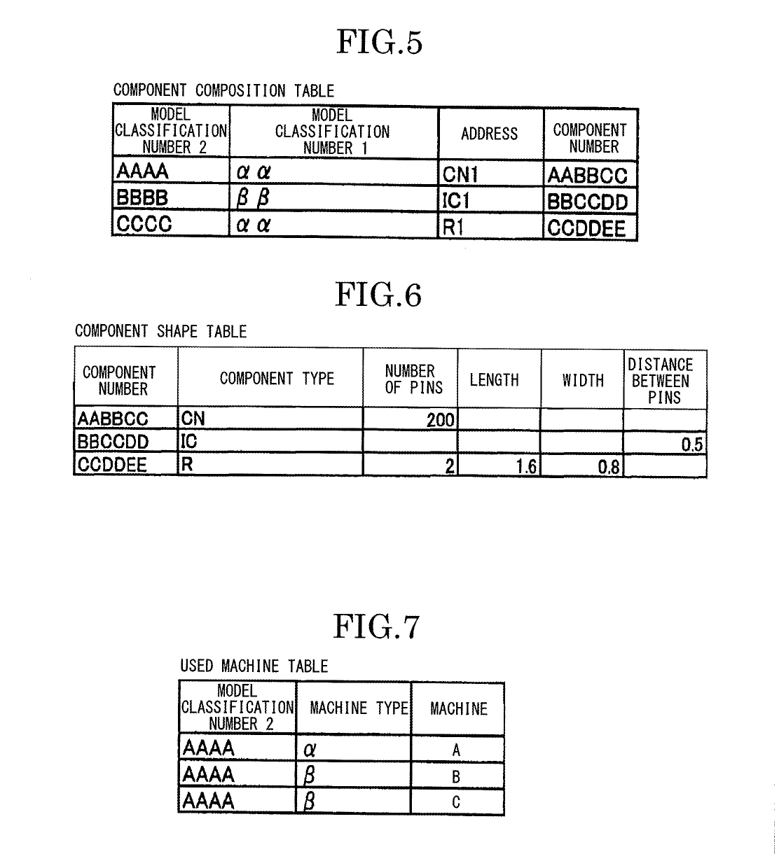

The component composition table 12 stores, as illustrated in FIG. 5, an address, a component number and the like of a base component of an assembly and each component to be assembled to the base component. This table includes a model classification number 2, a model classification number 1, an address, a component number and the like.

The component shape table 13 stores, as illustrated in FIG. 6, a size and a feature of each component according to assembly component number. This table includes a component number, a component type, a pin number, a length, a width, a distance between pins and the like.

The used machine table 14 stores, as illustrated in FIG. 7, information regarding a used machine which assembles a corresponding assembly component. This table includes a model classification number 2, a machine type, a machine name and the like.

The defect factor table 15 stores, as illustrated in FIG. 4, a first defect factor candidate (machine type, work, etc.) according to a defective item based on the inspection result (defect type) stored in the inspection information storing table 11. This table includes a defect type, a defect factor candidate and the like.

The quality information collection analysis section 16 refers to the production time storing table 9, the inspection information storing table 11, the component composition table 12, the component shape table 13, the used machine table 14 and the defect factor table 15, and analyzes the information stored in each table. For example, a target period for analyzing can be freely selected. A target item for analyzing can be freely set. In addition, the number of defects can be calculated according to a defective item, the selected model classification and the selected machine.

A display section 17 displays various information output from the quality information collection analysis section 16.

In a plurality of production and assembly lines for a component, a unit or a product including at least one assembly installation having at least one assembly machine which assembles components, a production time of each assembly machine (a production start or end time (a time when an assembly machine assembles an assembly component)) is input to the input section 8. The production time (a time when an assembly passes through each assembly machine) is stored in the production time storing table 9.

That is, the assembly machine automatically outputs the production time to the input section 8. The production time storing table is drawn up from this time information. As a method of inputting to the input section 8, automatic input from each machine or manual input can be used. In this embodiment, since identification information of an assembly is read by a bar-code at a time when an assembly lot passes through each assembly machine, that time is input to the input section 8 as a production time.

The inspection results of each assembly by each inspection machines 5-7 are input to the input section 10, and are stored in the inspection information storing table 11. The inspection information stored in the inspection information storing table 11 and obtained from the inspection machines 5-7 is identification information, existence of a defect of an inspected component, and an address and a defect type of a component when the component includes a defect. The information can be automatically input to each input section 10 from each inspection machine or can be manually input to the input section 10. For example, both of a method which manually inputs information written on paper by an inspector to the input section 10 and a method which automatically inputs inspection results output from each inspection machine to the input section 10 can be performed.

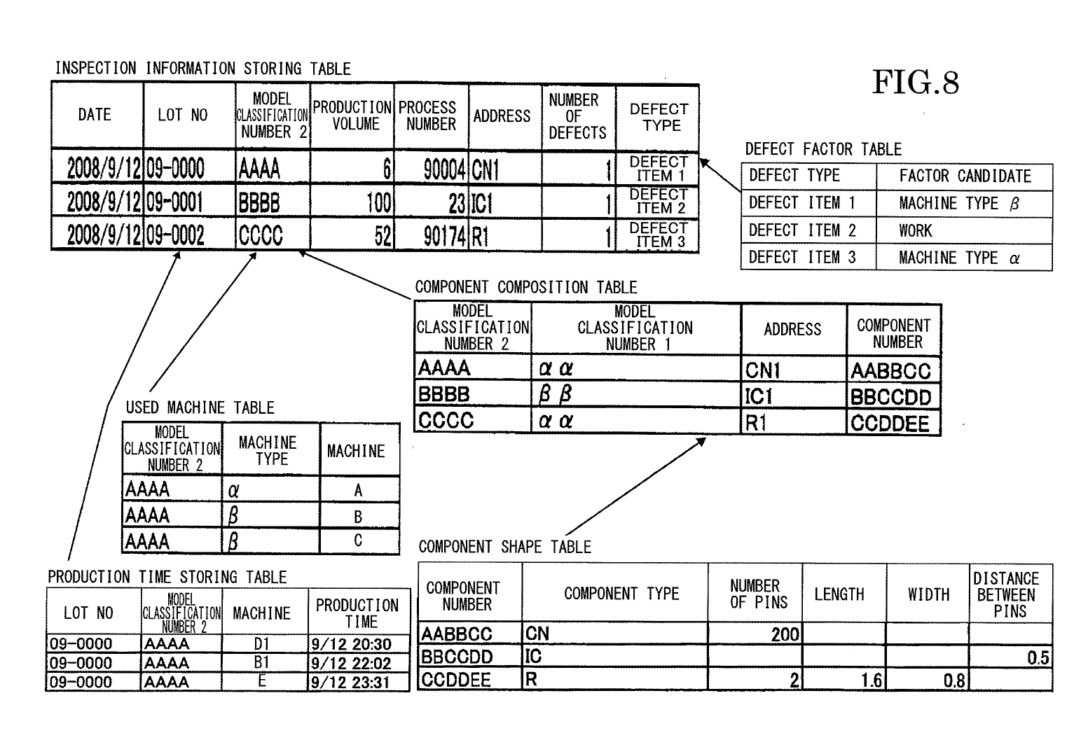

The storing section 20 includes the three tables of the component composition table 12, the component shape table 13 and the used machine table 14. The data of these three tables are related to each other as illustrated in FIG. 8, and can be used to quickly obtain information such as a type of a corresponding component and a machine which is used for assembling a corresponding component.

The storing section 21 includes the production time storing table 9, the inspection information storing table 11 and the defect factor table 15.

The first defect factor candidate in each defective item can be promptly known from the defect factor table 15.

The quality information collection analysis section 16 refers to the inspection results input to the inspection information storing table 11, the production time storing table 9, the component composition table 12, the component shape table 13 and the used machine table 14, so as to quickly determine a defect factor.

In the quality collection analysis device 1, a target period for analyzing can be selected. An output display method of analyzed results can be also selected from a plurality of output display methods, such that the analyzed results are classified (model classification number 1) according to model based on the base component of the assembly, and are output to be displayed, the analyzed results are also classified (model classification number 2) according to mode based on the component composition and the component position, and are output to be displayed, or the analyzed results are also classified according to machine, and are output to be displayed. In addition, a predetermined period, for example, daily intervals or weekly intervals can be automatically selected for the target period for analyzing and the display period. The target period for analyzing and the display period can be manually set. The target period for analyzing and the display period can be a period every time a predetermined number of productions are completed.

The quality collection analysis device 1 can seek the machine which has assembled the corresponding component, the time when the component is assembled, and the shape of the component by the quality data of the target period for analyzing (freely selected period) by referring to the component composition table 12, the component shape table 13, the used machine table 14 and the production time storing table 9.

The quality collection analysis device 1 can calculate the number of defects with respect to each inspection result (defective item), to the selected model classification or the selected machine in the target period (freely selected period) for analyzing.

The quality collection analysis device 1 can display the number of defects by a graph, which is calculated with respect to each inspection result (defective item), to the selected model classification or the selected machine in the target period (freely selected period) for analyzing.

The quality collection analysis device 1 can calculate the number of defects with respect to each inspection result (defective item) in chronological order according to production lot based on the selected model classification method in the target period (freely selected period) for analyzing. The calculated number of defects can be displayed by a graph.

The quality collection analysis device 1 can analyze the machine which has assembled the defective corresponding component, the time when the defective corresponding component is assembled and the shape of the component in a target period for analyzing by referring to the storing section 20 (component composition table 12, the component shape table 13 and the used machine table 14) and the production time storing table 9. The analyzed results can be displayed by a table.

The quality collection analysis device 1 can analyze the machine which has assembled the defective corresponding product, the time when the defective corresponding product is assembled, the shape of the component and the first defect factor candidate in a target period for analyzing by referring to the component composition table 12, the component shape table 13, the used machine table 14, the production time storing table 9 and the defect factor table 15. The analyzed results can be displayed by a table.

FIG. 8 illustrates relationships between the inspection information storing table 11 and other tables. The production time storing table 9 relates to the lot number of the inspection information storing table. The used machine table 14 relates to the model classification number 2 of the inspection information storing table 11. The component composition table 12 relates to the model classification number 2 of the inspection information storing table 11. The component number of the component composition table 12 relates to the component shape table 13. The defect factor table 15 relates to the defect type of the inspection information storing table 11.

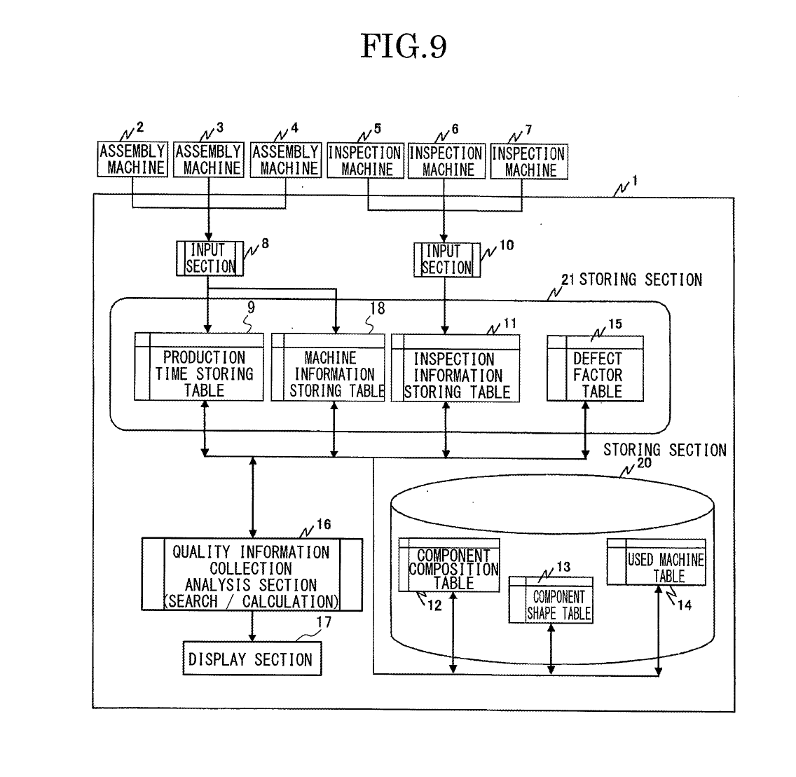

FIG. 9 is a view illustrating a flow of data necessary for the quality information collection analysis system when information regarding an assembly machine which actually assembles each component is used instead of or in addition to the used machine table 14 according to the embodiment of the present invention.

In the present embodiment, a machine information storing table 18, which stores information regarding an assembly machine which actually assembles each component, is added to the storing section 21. In addition, reference numbers in FIG. 9 are the same as the reference numbers in FIG. 1 for the similar parts, and only the added part will be described. Moreover, production information output from each assembly machine can be used.

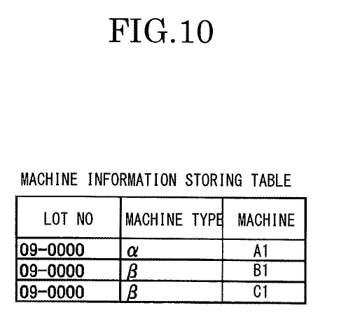

In the present embodiment, as illustrated in FIG. 10, the information output from each assembly machine which actually assembles each component is stored in the machine information storing table 18. This table includes a lot number, a machine type, machine information and the like.

For example, when data which can be used by a plurality of devices is stored in the used machine table 14, or when a plurality of installations are provided and a corresponding component can be assembled in any installations, the machine which has assembled the corresponding component can not be specified by the used machine table 14 illustrated in FIG. 1. In those cases, the machine which has assembled the corresponding component can be specified by using the machine information stored in the machine information storing table 18.

Accordingly, in the present embodiment, the machine information storing table 18 which stores machine information is used instead of or in addition to the used machine table 14. The machine information can be automatically input from each machine or can be manually input. In this embodiment, a method which inputs the machine information uploaded in a data base to the machine information storing table 18 is used.

FIG. 10 illustrates the structure of the machine information storing table 18. The information regarding a machine which has actually assembled a corresponding component is stored in the machine information storing table 18. This table includes a lot number, a machine type, machine information and the like. When the machine “B” includes the machines “B1”, “B2” each having the same NC machine (data), for example, the machine “B” is only listed in the used machine table 14. However, in the machine information storing table, the machines “B1”, “B2” and the like are listed, so that the machine which has actually assembled the component can be specified.

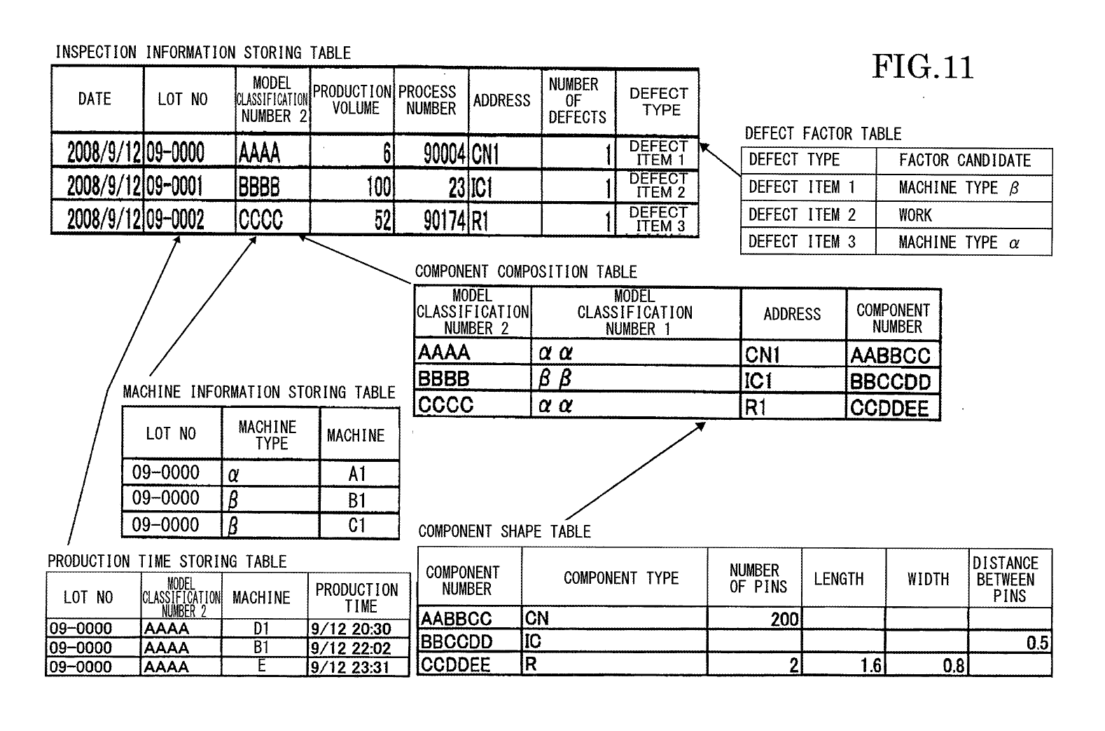

FIG. 11 illustrates relationships between the inspection information storing table 11 and other tables. The production time storing table 9 relates to the lot number of the inspection information storing table 11. The machine information storing table 18 relates to a lot number of the inspection information storing table 11. The component composition table 12 relates to the model classification number 2 of the inspection information storing table 11. The component number of the component composition table 12 relates to the component shape table 13. The defect factor table 15 relates to the defect type of the inspection information storing table 11.

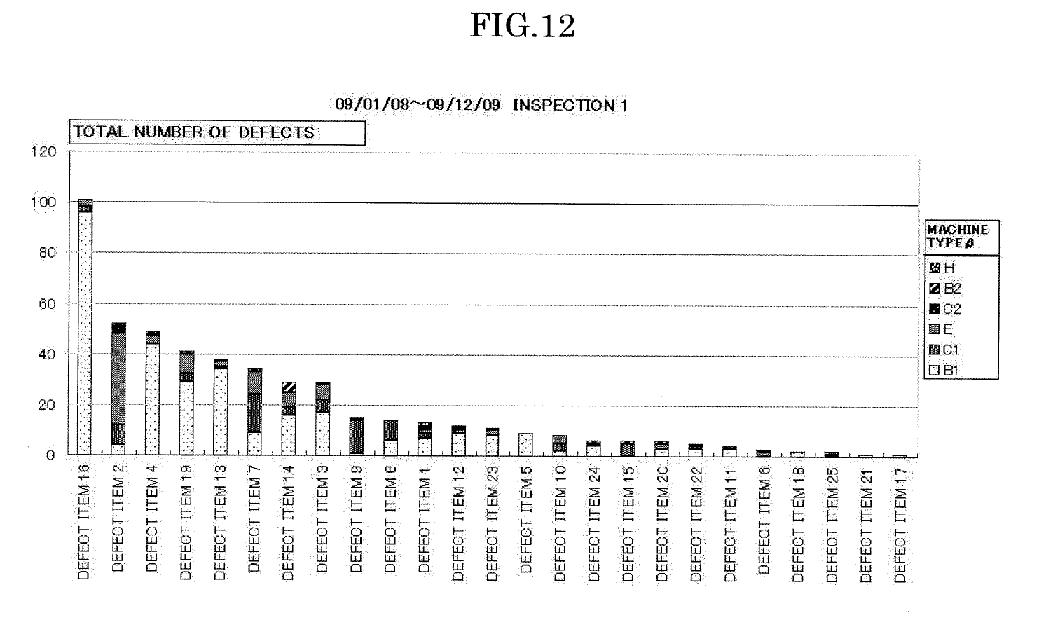

FIG. 12 is an example of display output of a stacked bar graph according to a defective item. FIG. 12 is a stacked bar graph illustrating the number of defects according to a defective item in a previously set period according to the machine of the machine type β. With this graph, a machine having a lot of defects which occur in a specified period can be promptly known.

In the present embodiment, a production time (time when an assembly passes through each assembly machine) of each machine in each installation is stored in the production time storing table which stores a production time of each machine. Therefore, when an interval between a production time and a production time is larger than a normal time interval, it can be known that an installation (machine) which has assembled a component in that time interval has a problem. Namely, an actual machine which has assembled the defective assembly component can be specified.

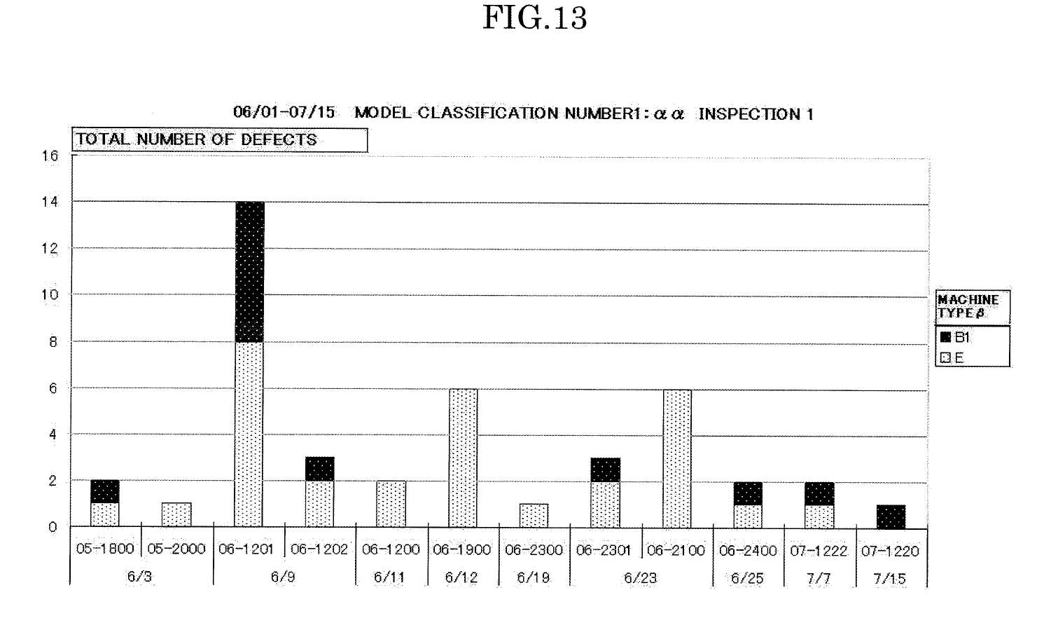

FIG. 13 is an example of a display output of a stacked bar graph according to lot regarding specified models. FIG. 13 is a stacked bar graph illustrating the number of defects according to lot in a previously set specified period according to the machine of the machine type β. With this graph, information regarding a defect such as a lot having a lot of defects which occur in a specified period, a sudden defect and a chronic defect, and an effect when a measure is taken to the machine type β can be quickly obtained.

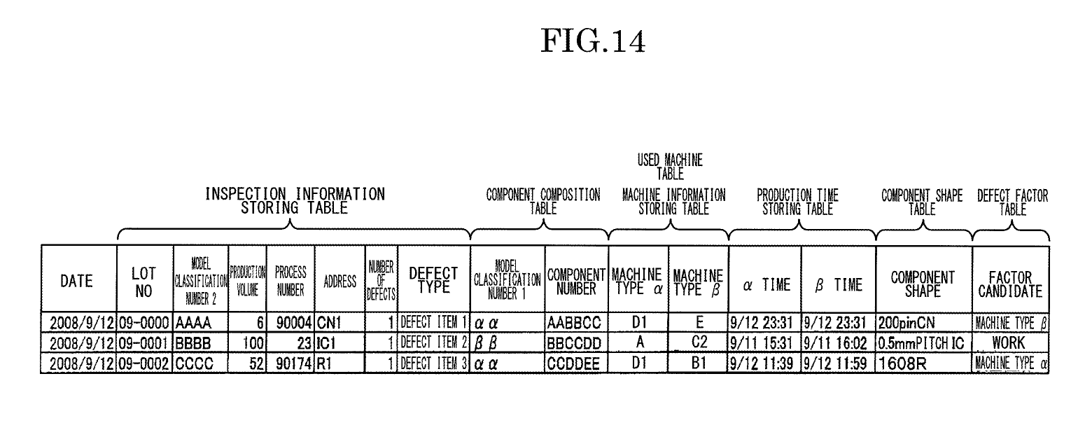

FIG. 14 is an example of display output of a table which can freely set display items. With the table illustrated FIG. 14, a type of a corresponding component, a time and a machine which has assembled the corresponding component can be easily obtained. Therefore, when an assembly error occurs, the defect factor can be promptly obtained. In addition, by obtaining the first defect factor candidate, the calculation according to defect factor can be easily conducted, so that a priority of countermeasure can be quickly added, and the effect of the countermeasure can be promptly obtained.

According to the above embodiment, by storing the component composition data, the component shape data, the used machine data and the production times in addition to the inspection information, a shape of a defective component, a defect occurrence time, a machine used for assembling and the like can be displayed by a table or a graph.

According to the above embodiment, a defect factor candidate is displayed, so that a defect factor can be figured out without having specific information regarding an assembly installation.

According to the above embodiment, a defect occurrence condition can be chronologically obtained, so that the details of the defect occurrence condition can be figured out, for example, whether it is an accidental defect or not, whether it is a chronic defect or not, or whether an effect is achieved or not when a countermeasure to the defect is taken.

According to the above embodiment of the present invention, even if a machine used for actual assembling is not found by the used machine table 14, a machine used for actual assembling can be specified by using the machine information table 18.

The quality information collection analysis system according to the embodiment of the present invention includes the display and output section which displays and outputs the results analyzed in the quality information collection analysis section 16. The display and output section displays by a table or a graph in accordance with freely settable display items.

The display and output section of the quality information collection analysis system according to the embodiment of the present invention can output the analyzed results every time the predetermined number of assemblies is completed.

The display and output section of the quality information collection analysis system according to the embodiment of the present invention can output the analyzed results at a predetermined time.

The assembly machine of the quality information collection analysis system according to the embodiment of the present invention includes the machine information output section which outputs information of an assembly. The quality collection analysis device includes the machine information input section which inputs assembly information output from the machine information output section. The quality information collection analysis section can analyze a defect factor using assembly information.

The quality collection analysis device of the quality information collection analysis system according to the embodiment of the present invention includes the defect factor table in which defect types and defector factor candidates are associated. The quality information collection analysis section can analyze the first defector factor candidate by using the defector factor table.

According to the embodiment of the present invention, the quality information collection analysis system can be applied to a system which collects quality information and searches the contents in production installations.

According to the embodiment of the present invention, a cause of a defect in a production installation can be quickly determined.

Although the embodiment of the present invention has been described above, the present invention is not limited thereto. It should be appreciated that variations may be made in the embodiment described by persons skilled in the art without departing from the scope of the present invention.

What is claimed is:

1. A quality information collection analysis system comprising:
at least one assembly installation having at least one assembly machine which assembles a component, and outputs an assembly time of an assembly as a production time;
at least one inspection machine which inspects the assembly to which the component is assembled by the assembly machine, and outputs an inspection result of the assembly as inspection information; and
a quality collection analysis device which manages quality information of the assembly, having a storing section which stores information of the component, the production time and the inspection information and a quality information collection analysis section which analyzes a defect factor of the assembly by using the information of the component, the production time and the inspection result.

2. The quality information collection analysis system according to claim 1,
wherein the quality collection analysis device includes a display section which outputs and displays a result analyzed in the quality information collection analysis section as the inspection information, and
the display section displays the inspection information by a table and/or a graph in accordance with a freely settable display item.

3. The quality information collection analysis system according to claim 2,
wherein the quality collection analysis device displays the inspection information on the display section every time a predetermined number of assemblies are completed.

4. The quality information collection analysis system according to claim 2,
wherein the quality collection analysis device displays the inspection information on the display section at a predetermined time.

5. The quality information collection analysis system according to claim 1,
wherein the assembly machine outputs information of the machine used for assembling the assembly as machine information, and
the quality information collection analysis section analyzes the defect factor of the assembly by using the machine information.

6. The quality information collection analysis system according to claim 1,
wherein the storing section previously stores a factor of the defect as a defect factor candidate, and
the quality information collection analysis section selects the defect factor candidate of the defect in accordance with the inspection information.
